(19) United States
(12) Patent Application Publication
(10) Pub. No.: US 2007/0150581 A1
(43) Pub. Date: Jun. 28, 2007

(54) System and method for monitoring system performance levels across a network

(75) Inventors: Supratim Banerjee, Boca Raton, FL (US); Joseph D. Beeler, Greensboro, NC (US); Anil Dwarkanath, Bangalore (IN); Martin Kartzmark, Weston, FL (US); Gautham Srihari, Troy, MI (US)

Correspondence Address: FITZPATRICK CELLA (AMEX), 30 ROCKEFELLER PLAZA, NEW YORK, NY, 10112, US

(73) Assignee: American Express Travel Services, Co., Inc. a New York Corporation, New York, NY (US)

(21) Appl. No.: 11/314,093

(22) Filed: Dec. 22, 2005

(51) Int. Cl. G06F 15/173

(52) U.S. Cl. 709/224

(57) ABSTRACT

Method of monitoring performance levels across a network, including steps of monitoring in real time performance levels of (i) at least one program application operating on the network, and (ii) at least one component of infrastructure of the network, and consolidating and storing data corresponding to the monitored performance levels. The method further includes steps of monitoring trends in the performance levels of at least one of (i) the at least one application, and (ii) the at least component of infrastructure, and mitigating, using the monitored trends in performance levels, incidents detrimental to capabilities across the network, which are potential outcomes of the monitored trends.

### BACKGROUND OF THE INVENTION

1. Field of the Invention

The present invention generally relates to a system and method for monitoring performance of hardware components (i.e., aspects of infrastructure) and software applications operating on those components in order to detect and if possible mitigate problems detrimental to the health and/or performance of the hardware and/or software. More specifically, the present invention is directed to obtaining and processing indicators of present or potential future situations detrimental to hardware components and software running on those components by proactively alerting users to the indicators and/or automatically circumventing problems indicated by the indicators. Furthermore, the present invention relates to a novel interface for providing the indicators to a user in an efficient and useful manner.

2. Related Art

Network computing is becoming increasingly prevalent for companies large and small. As these networks, and similar communication systems, grow in size and usage, increasing pressure is put on system administers to maintain the performance levels, health, and availability of resources of infrastructure and applications operating on that infrastructure.

Consequently, there is a drive to reduce problems such as crashes, unavailability of hardware components of the infrastructure or of software operating thereon, high error rates, and reduced transaction speeds, among others. There are existing products available to help system administrators in dealing with and reducing these problems. Many of the available products, however, are difficult to install and use. For instance, such products often require that a hardware agent device be placed at hardware components that are to be monitored, such that the agent device may send a message to the system administrator when specific problems the device is adapted to detect are detected; however, these individual devices operate as small patches on complex systems.

To date, there is no simple product for monitoring an array of hardware and/or software systems across a network, simultaneously, and providing a system administrator with a useful graphical user interface (GUI) which provides an overview of information necessary to monitor performance across the network. In addition, previously available products, which often are merely small patches, do not maintain historical data relating to the health and performance of the monitored components over time, so as to allow for more sophisticated analysis of trends so as to predict future events.

In addition, these small patch devices for monitoring an individual piece of hardware or software do not provide mechanisms that allow the system automatically to correct or circumvent problems to avert detrimental drops in performance levels.

In sum, existing products aid in monitoring potential problems in individual devices, while what is truly needed is a comprehensive monitoring system which provides system administrators with a centralized overview of the health and performance of multiple components for which they are responsible. In view of the foregoing, what is needed is a system, method and a computer program product for monitoring system performance levels across a network.

### BRIEF DESCRIPTION OF THE INVENTION

The present invention meets the above-identified needs by providing a system, method and computer program product for monitoring system performance levels across a network.

An advantage of the present invention is that it monitors performance levels of multiple hardware components and/or software applications across a network. The performance levels are preferably defined by different measurements or values that are indicative of the performance and health of the various components and applications being monitored.

Another advantage of the present invention is that it provides to a system administrator, though a user interface, an overview of multiple components and/or applications being monitored in a manner which allows the system administrator to view the status of the monitored performance levels simultaneously. Further, the monitoring system may provide alerts regarding problems in the monitored components or applications to the system administrator and/or automatically detect and circumvent the problems without further action by the system administrator. Moreover, the various measurements of the health and performance levels of the various components or applications are preferably stored over time so that the system can provide reports on historical data and trends in the monitored data.

Yet another advantage of the present invention is that it provides a novel GUI which displays an overview of the individual hardware and software systems being monitored along with data indicative of various measures of health and performance levels of those systems in a single comprehensive view. Further, the GUI allows a user to select information from various areas of the display for a more detailed report on the same, and alerts the user to potential problems using visual cues in the display that draw attention to measurements that surpass predetermined threshold levels (whether the levels are surpassed by dropping below or going above the threshold level). Preferably, the user may alter the views and adjust threshold levels to tailor the system as needed.

It is preferable that the information is obtained from the various hardware and software systems in real time (preferably about every second), while the GUI may be updated every minute (or other useful interval) to show the measurements within a set period of time (for instance, being updated every minute to provide the data collected over the previous five minutes).

One embodiment of the present invention is a method of monitoring performance levels across a network. The method involves monitoring in real time performance levels of (i) at least one program application operating on the network, and (ii) at least one component of infrastructure of the network (which may include any hardware component of the network that has a monitorable performance level), and consolidating and storing data corresponding to the monitored performance levels. The method also involves monitoring trends in the performance levels of at least one of (i) the at least one application, and (ii) the at least one component of infrastructure, and mitigating, using the monitored trends in performance levels, incidents detrimental to capabilities across the network, which are potential outcomes of the monitored trends.

Another embodiment of the present invention is directed to a graphical user interface displayed on a display connected to a computer operating the graphical user interface. The GUI includes a first display area listing components of infrastructure across a network. A second display area lists different categories of performance levels. A third display area includes a plurality of sub-areas, each sub-area displaying a performance level measurement corresponding to one of the different categories and pertaining to one of the listed components. A fourth display area displays additional information relating to at least one of (i) a performance level category and (ii) at least one performance level for a particular component. A user may select information displayed in at least one of the first, second, and third display areas to cause the graphical user interface to display additional information concerning the user-selected information.

Further features and advantages of the present invention as well as the structure and operation of various embodiments of the present invention are described in detail below with reference to the accompanying drawings.

### BRIEF DESCRIPTION OF THE DRAWINGS

The features and advantages of the present invention will become more apparent from the detailed description set forth below when taken in conjunction with the drawings in which like reference numbers indicate identical or functionally similar elements. Additionally, the left-most digit of a reference number identifies the drawing in which the reference number first appears.

FIG. 1 schematically illustrates a system diagram of a network having hardware and software monitored in connection with an embodiment of the present invention.

FIG. 2 is an example of a graphical user interface (GUI) according to an embodiment of the present invention.

FIG. 3 is an example of a pop-up window appearing in the GUI of FIG. 2.

FIG. 4 is another example of a pop-up window appearing in the GUI of FIG. 2.

FIG. 5 is an example of a report generated by an embodiment of the present invention to present historical data monitored over time.

FIG. 6 is a flow chart illustrating a monitoring process according to an embodiment of the present invention.

FIG. 7 is another flow chart illustrating yet another monitoring process according to an embodiment of the present invention.

FIG. 8 is a flow diagram illustrating another monitoring process according to an embodiment of the present invention.

### DETAILED DESCRIPTION

### I. Overview

The present invention is directed to a system, method and computer program product for monitoring performance levels of hardware components and software applications across a network. The present invention is also directed to a graphical user interface (GUI) for displaying the monitored data. The present invention is now described in more detail herein in terms of the above exemplary system and method for monitoring system performance levels and exemplary GUI. This is for convenience only and is not intended to limit the application of the present invention. In fact, after reading the following description, it will be apparent to one skilled in the relevant art(s) how to implement the following invention in alternative embodiments (e.g., alternate monitoring criteria, alternate GUIs, alternate monitored components, etc.).

The terms “user” and “system administrator”, and the plural form of these terms are used interchangeably throughout herein to refer to those persons or entities capable of accessing, using, being affected by and/or benefiting from the tool that the present invention provides for monitoring system performance levels of various components and applications.

Furthermore, the term “performance levels” refers to expressions of various measurements of performance and/or health of hardware components or software applications, which may include, but are not limited to, the number of errors experienced, speed at which web pages are reloaded, how fast a system switches between web pages, CPU (i.e., percentage of the CPU's capacity being utilized at the time of measurement), minimum and maximum transaction speeds, etc. In addition, this term may refer to values of measurements that, on their own may not be indicative performance and/or health of hardware components or software applications, but may be indicative of the same when taken in view of other measurements. For instance, such measurements may include the number of users using a particular application, the number of transactions being handled by the software. The measurements can be expressed in any number of ways, including numerical values, graphs, graphical indicators, color coding, etc.

The term “trends,” as pertains to trends in performance levels, may refer to the simple trends, including the tracking (for display, analysis, or otherwise) of changes in measured values over time, or complex trends including (i) the surpassing of threshold levels, for tracked data, set by a rules engine, and (ii) the surpassing of such thresholds in combination with other predetermined factors, such as surpassing a threshold for a predetermined period or longer. Such trends are used to monitor, automatically by the computer or through display to a user, actual or potential degradations in system performance. Furthermore, with respect to threshold levels, this application refers to “surpassing” such thresholds. The term “surpass” should be understood as including any crossing of a threshold value by a monitored parameter, where the crossing serves as a triggering event, whether the measurement drops below or rises above the threshold value.

The term “hardware” may be used to refer to any tangible part of a computer or network system that is monitored by the present invention. This may include hardware which is itself monitored (for instance, the CPU capacity measured for a processor), or hardware on which a software component being monitored is operating. The term “software” or “application” may be used to refer to any computer program to be monitored by an embodiment of the present invention, or running on a hardware component to be monitored.

“Historical data” refers to past measurements of performance levels which are saved on a database.

Also, the term “real time” is used in this application to refer to the updating of monitored information. While in a preferred embodiment the real-time monitoring is performed by retrieving data every second from monitored components, this term is not limited to that frequency of monitoring, and should instead be given a broad interpretation of regular updating. In this regard, while the retrieving of data may occur every second, the GUI discussed in more detail below may be updated less frequently (e.g., only every minute or so), to refresh the values displayed to a user.

### II. System

In one embodiment, the present invention is directed to a system for monitoring hardware components of an infrastructure, across a network, and software operating thereon, to retrieve from those elements data corresponding to performance levels of the hardware and software.

With respect to hardware, the components monitored may include servers, individual desktop or laptop computers, mainframe computers, and the like. In most preferred embodiments, servers are primarily monitored. Such servers may be using any one of a number of operating systems from makers such as Windows®, Sun Microsystems®, Apple®, and the like. The monitored performance levels may include, but are not limited to, data concerning the number of users accessing the hardware component, logical memory availability (e.g., RAM), user queues, CPU utilization percentage (“CPU”), and other like data, as would be appreciated by one of ordinary skill in the art(s). It should be appreciated that some of these performance levels could also be considered measurements of the performance of applications operating on the hardware. For instance, user queues can be taken as the number of users waiting to use an application operating on the hardware, rather than the hardware itself. Such dual interpretations should be embraced throughout the application. Also, with respect to mainframe computers, in preferred embodiments, typically lower level measurements are made concerning this hardware, such as response times or the like (although the invention is not limited thereto).

With respect to software applications, in preferred embodiments, the applications being monitored are web-based applications, but any one of a number of applications running on hardware components may be monitored in accordance with embodiments of the present invention. In monitoring software applications, performance levels that can be measured include data relating to the number of users using the software, the number of transactions per unit of time or per user (or both), the types of user request, the frequency of repeat request, error rates, error types, timing to complete requested tasks (including minimum times, maximum times, and mean times), and other like measurements indicative of the health, performance level, or even general operation of the application(s).

In detecting performance levels (or the data underlying the expressions of performance levels), the monitoring system may determine the speed at which software is performing requested actions, the number of times one or more particular users have to request the same action, the number and types of functions being performed, etc., which lead to an overall picture of the health and performance of the application(s). Other monitored information may address stacking information, in which the monitoring system determines where a breakdown in a task set occurred, when the task set involves multiple tasks performed in different areas. This allows the system to determine where in the chain of tasks the failure occurred.

As will be appreciated by one of ordinary skill in the relevant art(s), any one or more of a number of additional measurements can be included in the monitored performance levels. The present invention is not limited to the specific types of data enumerated herein as being included in the definitions of performance levels.

A monitoring system for obtaining and assessing performance levels in an embodiment of the present invention can operate to obtain the necessary data in a number of ways. With respect to monitoring software applications, it is preferable, at the time of installation of the software on a hardware component, to write code into the application which instructs the software to track, time, and/or otherwise obtain events or information related to the performance levels of interest, and to store the data for retrieval by the system. Typically, code will be added that causes the software to store the data in an event log file, from which the system can readily retrieve the information. Such coding practice will be understood by one of ordinary skill in the relevant art(s). Consequently, the monitoring system can query a remote application and retrieve from the event log file information needed to construct the report on performance levels to be provided to a system administrator.

With respect to hardware, the retrieval operations work much the same way as in the software applications. Specifically, hardware systems use operating systems to operate, and operating systems are themselves software. With respect to the hardware, however, typical operating software commercially available for mainframes, servers, and desktop computers includes event log files that accumulate information of interest to an embodiment of the present invention. Consequently, a monitoring system according to an embodiment of the invention can retrieve the information of interest from the log files of the operating system (for instance, Windows.NET®, or the like). Thus, the present invention can utilize features and information exposed by a Windows® operating system or the like. Alternatively, similar to the software applications discussed above, code can be written into an operating system in order to detect and store the necessary information in event log files for later retrieval.

In an embodiment of the present invention, a monitoring server (or servers), or other hardware device, has an operating system or other software that operates to query remote components and retrieve the data relevant to the monitoring of performance levels of components across the network. Inasmuch as the code for storing such information in the event log files may be written into the application(s) at the time of installation, data items in the files are provided in a format understandable by the application(s) of the monitoring server. Alternatively, the monitoring server can be programmed to accept data formats already stored by a commercially available operating system or the like.

Preferably, the monitoring server retrieves such information in real time. Most preferably, the real time acquisition occurs on the order of approximately every second. The monitoring server software retrieves and, if necessary, analyzes the data from the log files to compile the relevant information and form the measurements of performance levels to be provided to the user.

The formulated measures of performance levels can then be provided to a system administrator in a cohesive overview in one or more GUIs (discussed in more detail below), so as to provide a high-level picture of the components and applications being monitored. In addition, the monitoring server(s) can store the retrieved data or formulated performance levels in order to produce reports on historical trends and to chart performance over time.

These features and other features of a system according to an embodiment of the present invention are discussed in more detail below with respect to the figures.

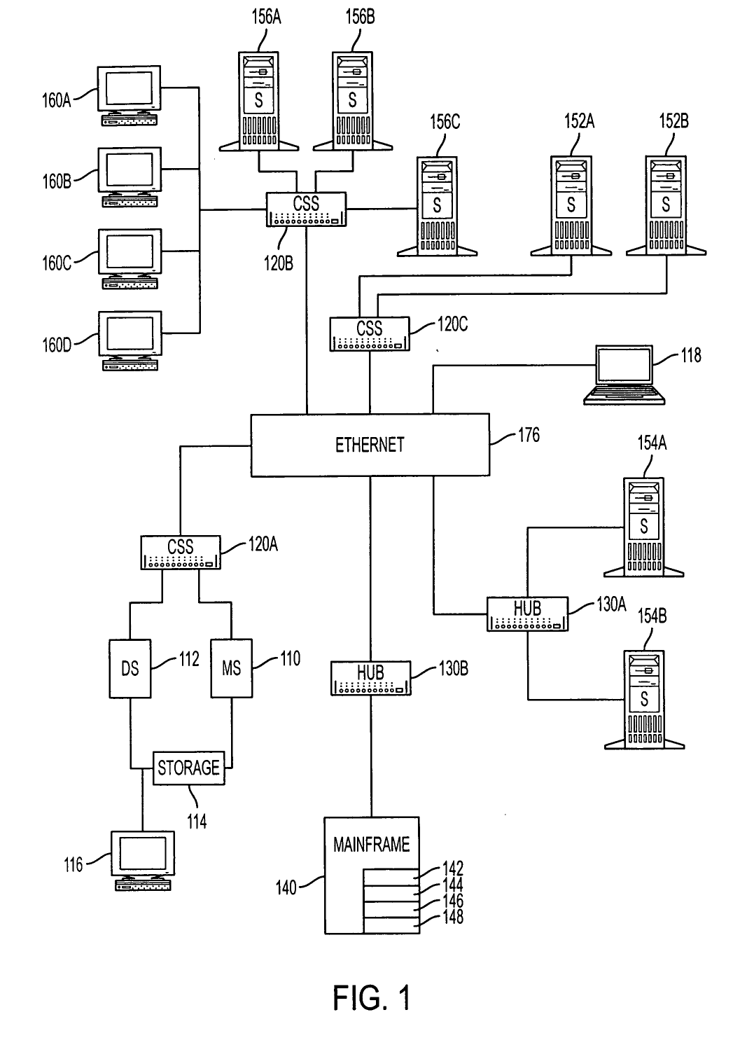

FIG. 1 shows an example of a monitoring system according to the present invention. The system shown in FIG. 1 includes a monitoring server (“MS”) 110 and database server (“DS”) 112, which perform the monitoring of this embodiment (although only one processing system is needed to form the monitor system, two servers are used in this example). Monitoring server 110 runs the software that retrieves, and in some instances analyzes, the data corresponding to the performance level measurements. Database server 112 may also run the software running on MS 110, and further runs software for storing and managing the historical data. Storage unit 114 stores the historical data managed by the software of DS 112. Interface 116 provides a user interface and display so that a system administrator can view the measurements of performance levels and use interactive features of the system, as discussed in more detail below with respect to an example GUI.

These components (MS 110, DS 112, storage 114, and interface 116) form an example monitoring system which is connected to Ethernet 170 by current smart switch (“CSS”) 120A. CSS 120A is also used to switch between DS 112 and MS 110, as may be necessary.

Also connected to Ethernet 170 is CSS 120B, which switches loads between servers 156A-156C. Servers 156A-156C provide service to server clients 160A-160D, which clients may be individual user computers or groups thereof at individual offices or regions.

CSS 120C connects servers 152A and 152B to Ethernet 170. In addition, hub 130A connects servers 154A and 154B to Ethernet 170, while hub 130B connects mainframe 140 to Ethernet 170. Mainframe 140 includes separate operating areas 142, 144, 146, and 148.

Servers 152, 154, and 156, mainframe 140, and clients 160 are monitored by MS 110. As discussed above, MS 110 monitors the hardware components and/or software running thereon. Consequently, MS 110 retrieves data relating to performance levels of the hardware and/or software through the connection to individual components across Ethernet 170. In a preferred embodiment, MS 110 retrieves such information from the necessary log files approximately every second. However, the timing for retrieving data from the log files to update the monitoring system can be varied based on design preferences.

The software running on the individual components, such as servers 156A-156C, stores data concerning performance levels and the health of the systems in log files in accordance with code dictating the same, which may have been written in the software when put on the hardware components, or which already exist as part of the application (for instance, features exposed by existing code in commercial operating systems).

MS 110 retrieves the necessary information from the log files such that the same is sent to MS 110 and DS 112, and stored in storage unit 114. MS 110, where needed, analyzes the data based on rules engines constructed in the application(s) running on MS 110. The rules engine for organizing and analyzing the data retrieved from the components across Ethernet 170 can be varied based on design preferences and monitoring requirements, as will be appreciated by one of ordinary skill in the art(s). The raw or analyzed data forms the measurements of performance levels of the hardware and software being monitored. The performance levels are provided to a system administrator through interface 116. Preferably, such measurements are provided on a display of interface 116 in a user friendly format which can be manipulated by the system administrator to provide such information in a suitable format.

While the data from the log files are typically retrieved approximately every second, it is preferred that interface 116 be updated less frequently, preferably about every one minute. In addition, since many of the performance levels are useful if expressed as rates, it is preferred that the measurements of performance levels be expressed to a system administrator as a measurement per unit of time, preferably about five minutes. For instance, where the measured performance levels is errors experienced by the application, while the MS 110 retrieves the error information from a log file every second, and the interface 116 is updated every minute with the retrieved information, the displayed performance level may be a value indicative of the number of errors experienced over the preceding five minute period (i.e., there is a new five-minute interval (which overlaps the last interval) provided every minute). Accordingly, the refresh of the system causes the display of interface 116 to display the number of errors over the last five minutes at a refresh rate of every one minute. However, this is only a preferred arrangement, and variations of the same may be used in accordance with preferred designs. In particular, where the performance level is not easily expressed as a rate, the display may show the average performance level measurement over the previous five minute period. In other embodiments, a user may adjust the refresh rates and period of measurement to better suit the user's needs or preferences.

In addition, remote interface 118 is connected through Ethernet 170 to MS 110 such that a system administrator may log on to the monitoring system remotely in order to obtain the data analyzed and provided by MS 110 and DS 112 (i.e., the performance levels to be displayed).

Also, while Ethernet 170 is shown, any one of a number of communication interfaces may be used to connect various hardware components to a monitoring system. In particular, communication interfaces may include a modem, alternate network interfaces, communication ports, Personal Computer Memory Card International Association (PCMCIA) slots and cards, etc. Software and data transferred via communications interfaces are in the form of signals which may be electronic, electromagnetic, optical or other signals capable of being received by communications interface. These signals are provided to a communications interface via a communications path (e.g., channel). Such channels carry signals and may be implemented using wire or cable, fiber optics, a telephone line, a cellular link, a radio frequency (RF) link and other such communications channels.

Storage unit 114 stores the raw and/or analyzed data for later use and further analysis. The memory of storage unit 114 is preferably a hard disk drive or drives. In other embodiments, the memory may include a removable storage drive, such as a floppy disk drive, a magnetic tape drive, an optical disk drive, etc. The removable storage drive may read from and/or write to a removable storage unit in a well-known manner. As will be appreciated, other memory devices may also be used.

The historical data stored in storage unit 114 may be used to generate reports on past activities or trends. In particular, weekly, monthly or quarterly reports may be generated to show the performance level information over time. In preferred embodiments, these reports may include charts tracking the health of components connected over the network. Such reports may also be generated in any of a number of manners to show and/or analyze trends which led to interruptions or problem events, so that the system administrator may identify issues which lead to detriments to system capabilities.

### III. Operation

In a preferred embodiment, MS 110 will query, through Ethernet 170, a server, such as server 156A, to access a log file thereof. The information in the log file can include data of any one of a number of performance levels or data related to such performance levels. For instance, the log file may include data concerning the CPU, as expressed as a percentage of capacity being used. MS 110 analyzes the retrieved data from the log file in accordance with one or more rules engines included in the software running on MS 110, which may include programs that read and react to data from the log file. For instance, MS 110 may retrieve from a log file of the operating system of server 156A data concerning the CPU measurement of that server. The rules engines are used to analyze the data such that, for example, if the CPU utilization passes a threshold level (e.g., 80%), the rules engine may instruct the system to react accordingly. The reaction, in addition to displaying, routinely, the performance level through interface 116 or remote interface 118, may include providing a separate alert to the system administrator. This alert can be defined as a pop-up menu on the display of interface 116 or 118, a color change in the display of the CPU percentage level or some other visual cue to direct attention to the passing of the threshold. In addition, MS 110 can alert a system administrator using email, a text message, or a page to a paging device. In a preferred embodiment, a system administrator can set the threshold at which the alert is provided. Furthermore, such alerts may be provided based on threshold levels for any one of the measured performance levels, or for various combinations thereof.

In addition to alerts, MS 110 can automatically circumvent or correct the problem in accordance with the rules engine. For instance, if MS 110 detects that server 156A has surpassed a threshold level for the CPU measurement, and remains above the threshold for a set period of time, the rules engine can dictate that MS 110 automatically discontinue the use of server 156A. In that case, CSS 120B switches the load to another server of the group, such as server 156B or 156C. Mechanisms for switching and using a CSS are well known in the art. In a preferred embodiment, the mechanism for using the CSS 120B to switch the load involves placing files on various servers, which indicate whether the server is available to handle a load. The CSS switch detects these files and switches among the servers based on the information indicated in those files. This automatic circumvention can be in lieu of an alert, or in addition to an alert. Thus, a problem or potential problem with a server in the network can be detected and addressed before it becomes detrimental to the network capabilities, either through actions on the part of the system administrator alerted by the monitoring system or, where the rules engine provides, by actions taken automatically by the system itself.

The monitoring system 110 can also be provided with rules governing re-checking of the health of server 156A after a set period of time, for instance 30 minutes, to determine whether the problem with that server has been corrected/addressed. Thus, system can determine the health of the server removed from use and work the server back into availability if the problem has been addressed, or re-check at a later time.

### IV. Graphical User Interface (GUI)

Another embodiment of the present invention is a novel user interface which integrates a wide array of data concerning performance levels of components across a network so that a system administrator can see an overview of the health of the hardware and software.

Preferably, a GUI of one embodiment of the invention lists the servers and/or mainframes being monitored, individually, and shows the monitored performance level information for each such that the system administrator can, in one view, see the hardware components being monitored, and various performance characteristics monitored for each piece of hardware. While hardware is referred to here, the performance level measurements will more often relate to the health of software running on those hardware components. The interrelation between hardware and software can be expressed on the GUI in any one of a number of ways useful to a user, as will be appreciated by one of ordinary skill in the relevant art(s).

In more preferred embodiments, the system administrator can select individual items in the GUI, for instance server names, displayed performance level measurements, or other displayed information (by double clicking or the like) to obtain additional information concerning the selected item. The additional information may be in the form of a pop-up window, new screen, or the like.

In addition, it is preferred that the GUI have graphical/visual cues for drawing attention to specific data displayed, where the data is indicative of a potential or existing problem (e.g., a set threshold for a performance level value has been surpassed). These graphical cues may include highlighting the text corresponding to the data to be alerted to a system administrator, changing the color in which the data is displayed, or any one of a number of other visual cues suitable for drawing a system administrator's attention to such an alert.

In other embodiments, or in addition to embodiments discussed above, the GUI may have a separate area for specifically listing alerts of problems or potential problems and providing information descriptive of the same.

In more preferred embodiments, other areas may be provided on the display of the GUI to provide more-detailed information on particular monitored data. For example, while a main display may show multiple performance level measurements with respect to different components across the network, including error rates of individual servers, a separate display may list the errors (or other information) by type. Thus, instead of the number of errors per server, this other area would list the total number of occurrences of a particular error, for all servers or all servers in a particular area of the network.

As can be imagined, any one of a number of formats can be used to provide the GUI according to an embodiment of the present invention, which shows information regarding (1) multiple pieces of hardware and/or software, (2) multiple pieces of data indicative of performance levels for the one or more pieces of hardware and/or software, (3) alerts based on set thresholds, and (4) interactive displays that allow prompting of more detailed information not initially observable on the top level display of the GUI.

With such a GUI providing data of performance levels and overall health of various components across a network, a system administrator can obtain a comprehensive picture of the performance of various components through a single graphical user interface, which allows the system administrator more efficiently to view, predict, and address problems across the network.

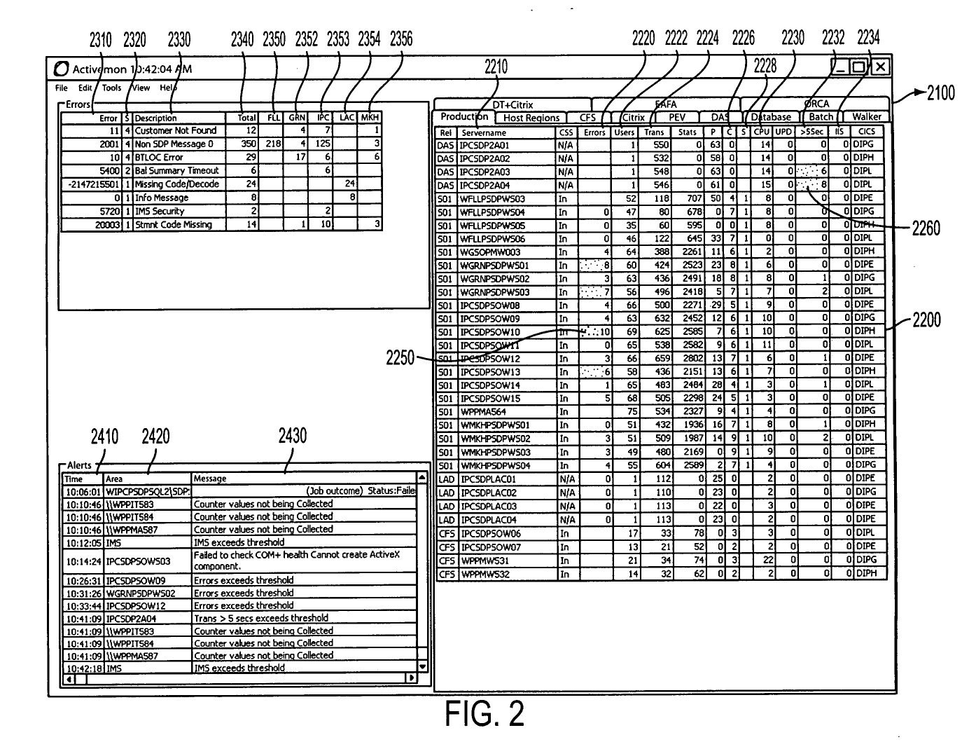

FIG. 2 shows an example of a GUI according to an embodiment of the present invention for providing a system administrator with a high level view of the health of various components.

FIG. 2 shows a GUI 2100 which includes display areas 2200, 2300, and 2400.

Display area 2200 shows performance level data corresponding to individual servers, provided in table format. Column 2210 (“Server name”) is an area that lists the names of individual servers being monitored by a system according to an embodiment of the invention. Across the top of the table of display area 2200 are listed categories of performance levels. In the column below each listed category are provided measurements of performance levels corresponding to the listed server names. In particular, column 2220 (“Errors”) lists the number of errors per server (or a specific application operating on the server). As discussed above, the number of errors shown is preferably the number of errors that have occurred over a set period of time, for instance, five minutes. Therefore, each of the values provided in column 2220 refers to the number of errors occurring on that server over the last five-minute period.

Column 2222 (“Users”) lists the number of users tapping into the software of that server over the last five-minute period. Column 2224 (“Trans”) indicates the number of transactions completed by those users over the period. Column 2226 (“C”) provides a value indicating the speed at which web pages on the server are being reloaded. Column 2228 (“S”) shows a value corresponding to the speed at which a server switches from one web page to another. Column 2230 (“CPU”) is a measure of CPU percentage. (Because the columns represent five-minute periods, CPU is preferably represented as an average percentage over the last five-minute period.) Column 2232 (“>5 sec”) refers to the number of transactions completed by the server (or particular application on the server) which took longer than five seconds each. Column 2234 (“IIS”) refers to the queue of users waiting to use the server or software operating thereon.

Shaded area 2250 in column 220 (corresponding to the row listing server “IPCSDPSOW10”) is a visual alert activated in response to the number of errors for that server over the last five minutes surpassing a threshold (e.g., a threshold of 9). Alternatively, a system administrator could be alerted to this area or value through use of color, blinking, text change, or the like. Shaded area 2260 in column 2232 (of the row listing server “IPCSDP2A04”) is an alert indicating that that server has surpassed the threshold for the number of transactions in a five-minute period that takes longer than five seconds per transaction. Shaded areas 2250 and 2260 are different so as to indicate different levels of alert. One of ordinary skill in the art would comprehend that different alert levels with different visual cues may be provided as deemed appropriate by the system designer or users.

Display area 2300 shows details corresponding to errors, as broken down by error type, rather than individual servers. Specifically, column 2310 (“Error”) indicates the error type by its assigned number. Column 2320 (“S”) is an indication of the severity of that particular error. The measure of severity (or levels thereof) can be determined and set based on design preferences. For instance, for a particular error, eight or more instances in a given period may be considered severe, and for another error, two or more instances may be considered severe. What constitutes “severe” for a particular error can be dictated by one of skill in the art in keeping with design preferences of the system. Column 2330 (“Description”) provides a description of the error type from column 2310. Column 2340 (“Total”) refers to the total number of occurrences of that particular error over a set period (e.g., the last five-minute period). Columns 2350-2356 indicate the number of errors, of the type from column 2310, occurring in different locations. For instance, column 2350 refers to “FLL”, which corresponds to “Florida”, and indicates, in that column, the number of errors of the corresponding type occurring in the system's Florida region.

Area 2400 list alerts triggered by the rules engines of the system. Column 2410 (“Time”) indicates the time of the error. Column 420 (“Area”) indicates the server or other hardware or software identified to which the alert pertains. Column 2430 (“Message”) describes the alert given at that time for that particular component.

For instance, row 2440 includes an alert corresponding to server “IPCDP2A04,” and column 2430 of that row indicates that the alert refers to a threshold being surpassed with respect to the number of transactions in that server taking in excess of five seconds. This alert corresponds to the shaded alert 2260 in display area 2200.

Thus, the multiple display areas of GUI 2100 provide alternative means for displaying information helpful in the comprehension of a system administrator.

In preferred embodiments, a system administrator may alter the views of relevant data displayed in GUI 2100, as necessary, and change thresholds as appropriate to tailor the GUI 2100 (and, consequently, the operation of the system operation) to the needs of the system administrator.

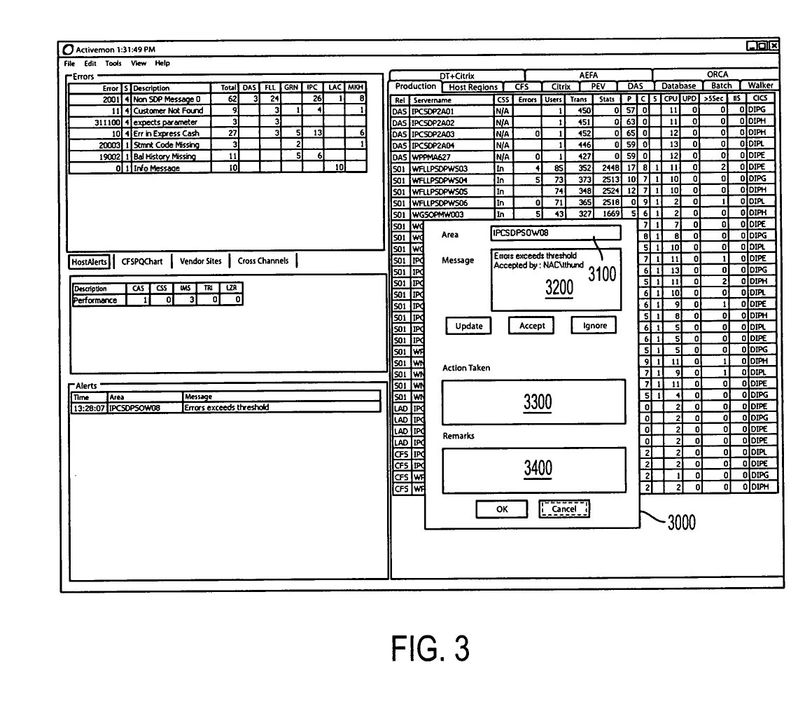

FIG. 3 shows a GUI similar to that shown in FIG. 2. In FIG. 3, however, there is a pop-up window 3000. Window 3000 is obtained by a user's selection of a server name listed in column 2210 of FIG. 2. Specifically, area 3100 shows that the server named “IPCSDPSOW08” was selected. Window 3000 provides additional information concerning the health of that server. In particular, area 320 provided additional detail concerning an alert for that server. Also, areas 3300 and 3400 allow a system administrator to add additional information relative to that server, as needed.

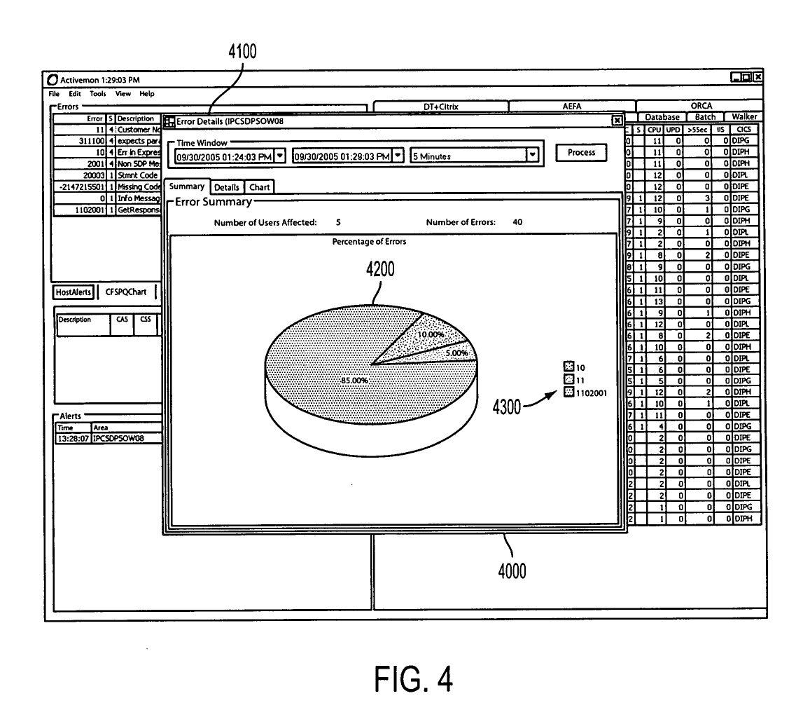

FIG. 4 shows yet another pop-up window on a GUI such as that shown in FIG. 2. Window 4000 is obtained by selecting an item from column 2220 of GUI 2100. Specifically, window 4000 is obtained by selecting the “error” performance level description corresponding to the server named “IPCSDPSOW08”. As can be seen, window 4000 includes a heading area 4100 that names the server. Window 4000 also includes a graph 4200 that breaks down the errors for that server by error type. Legend 4300 indicates the error types represented by the graph 4200.

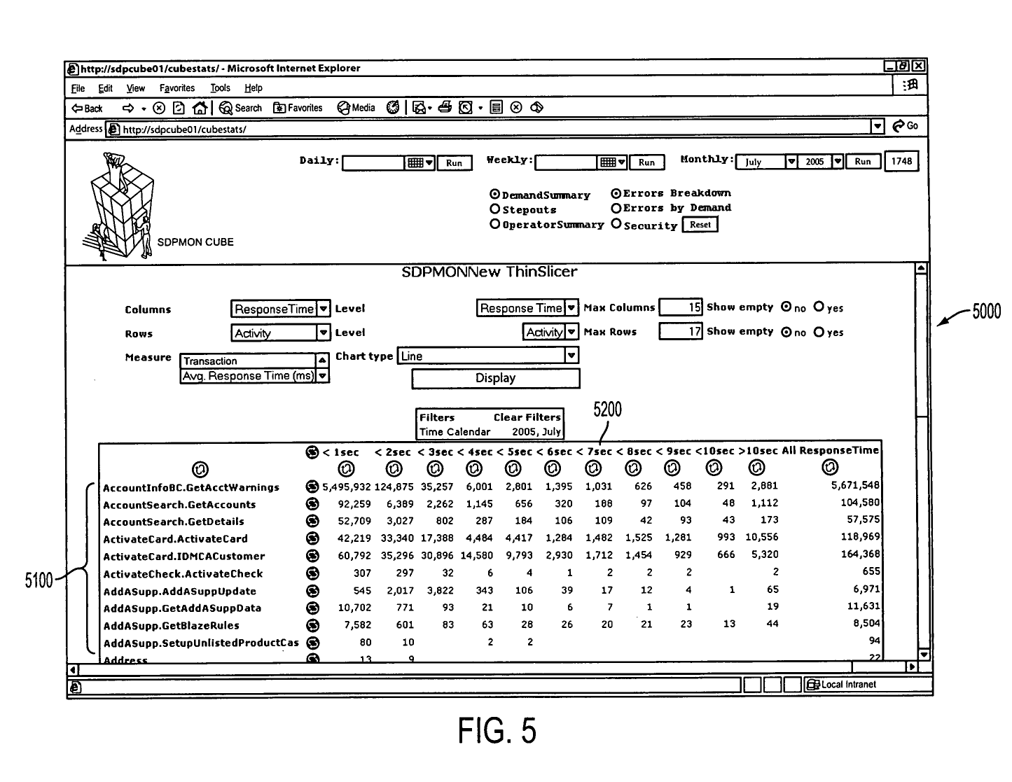

In addition, FIG. 5 shows a report 5000 generated by the system to summarize monitored trends. In particular, report 5000 includes an area 5100 listing varies software programs operating on hardware components across the network. For each application, there are listed the number of transactions that took longer than a stated time period. For instance, column 5200 lists, for each application, the number of transactions that took the software longer than 7 seconds to practice. As would be appreciated by one of ordinary skill in the art(s), any one of a number of reports may be prepared using the data consolidated and stored by the monitoring system.

### V. Process

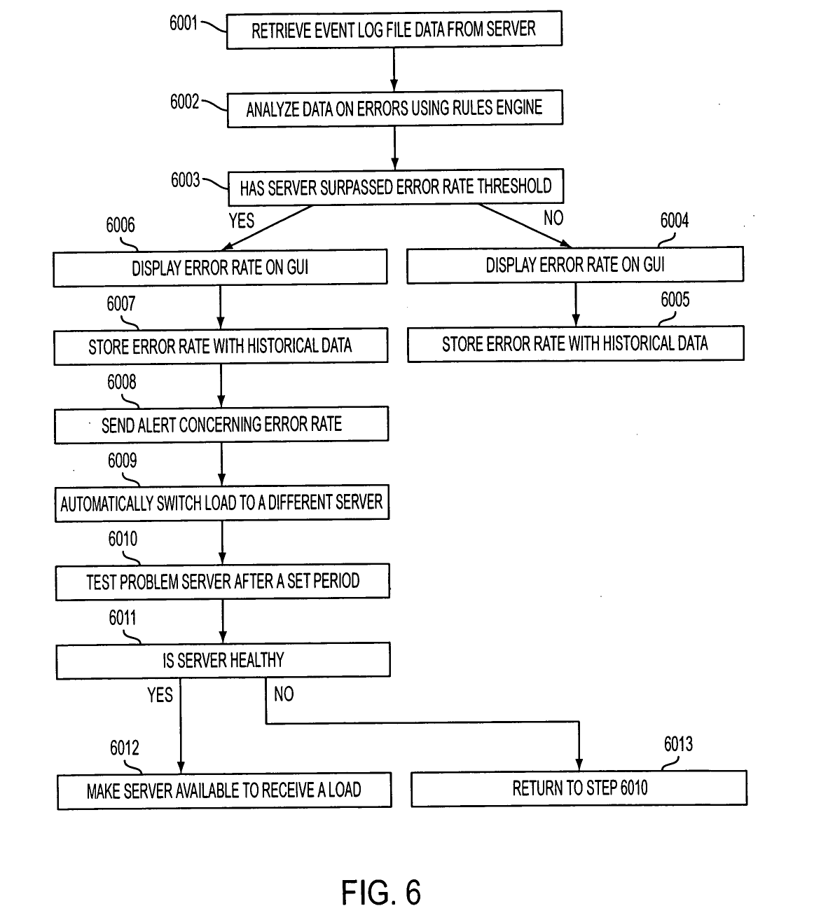

FIG. 6 shows a flow chart of an example of a monitoring process according to an embodiment of the invention. In step 6001, the system retrieves data from an event log file of a server. In step 6002, the monitoring server analyzes data corresponding to errors, using rule engines forming part of the software running the monitoring server. In step 6003, it is detected whether the server (or software operating thereon) has surpassed a threshold error rate, in accordance with the rules dictated by the monitoring system. If the error rate has not surpassed the threshold level, which would indicate a problem or potential problem, the process proceeds to step 6004, at which the error rate is displayed in the GUI to provide the information in a graphical format to a system administrator. In step 6005, the error rate information is stored in a database along with other historical data. As would be appreciated by one of ordinary skill in the art(s), steps 1004 and 1005, particularly, do not necessarily have to be performed in this order.

If it is determined in step 6003 that the error rate of the server has surpassed a threshold level, the process proceeds to step 6006, in which the error rate is displayed on the GUI in a manner similar to that of step 6004. In addition, in step 6007, the error rate is stored in a database with other historical data in a manner similar to that of step 6005. Again, the order of steps 1006 and 1007, in particular, are not in critical, and the order of these, and other steps, may be revised in accordance with what would be understood by one of ordinary skill in the art(s).

In step 6008, the system sends an alert concerning the error rate to a system administrator. This step may be achieved by, as discussed above, providing a visual cue in the GUI in which the error rate is displayed, or sending a separate message to the system administrator as dictated by the system preferences or settings entered by the system administrator. In addition to an alert, step 6009 involves automatically taking proactive steps to correct and/or prevent a problem detrimental to the health and performance of the component, or components. Specifically, in step 6009, the system automatically switches the load on the server having the error rate surpassing the threshold to an alternate server, thus circumventing the troubled server. In step 6010, the troubled server is tested for health and performance after a set period, in order to determine whether the server may be made available again. In step 6011, it is determined whether the server is healthy. If the server is healthy, in step 6012, the server is made available again. If the answer is no, then the process returns to 6010.

Thus, the example process shown in FIG. 6 involves both an alert and a circumvention step to proactively manage the health and performance of components of a network.

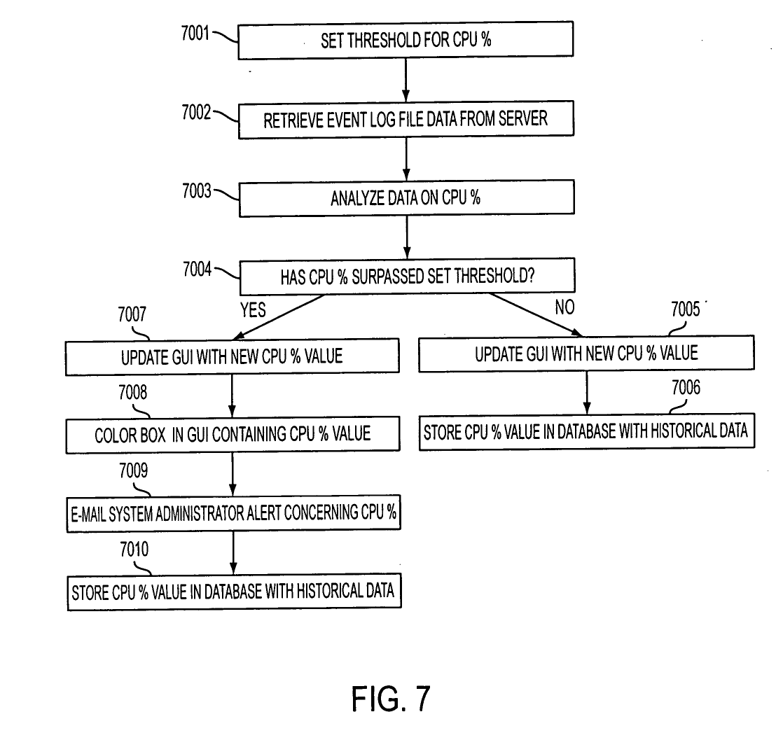

FIG. 7 shows another example of a process according to an embodiment of the invention, in which data concerning CPU performance is retrieved and analyzed.

In step 7001, the system administrator sets a threshold for CPU performance. For instance, the system may be set such that if 80% or more of the available processing ability of a processor is being utilized, the threshold is crossed (indicating that the available processing has been diminished to an unacceptable level (for instance, there is 20% or less availability). In step 7002, the system retrieves data from an event log file of a server being monitored. In step 7003, data from the event log file is analyzed with respect to CPU performance. In step 7004, it is determined whether or not the measured CPU percentage has surpassed the threshold set in step 7001. If the threshold has not been surpassed, the server is deemed healthy and the process proceeds to step 7005. In step 7005, the GUI providing a system overview to the system administrator is updated with the new CPU value. In step 7006, the CPU value is stored in a database with other historical data on performance levels.

If it determined in step 7004 that the measured CPU percentage has surpassed the threshold, the process proceeds to step 7007. In step 7007, similar to step 7005, the GUI is updated with the new CPU value. In step 7008, the box containing the updated CPU value is colored in order to alert the system administrator monitoring the GUI that the threshold level set in step 7001 has been surpassed with respect to the server from which the data from the log file was obtained. In step 7009, the system administrator is also emailed with an alert concerning the CPU. In step 7010, the new CPU value is stored in a database with other historical data on performance levels.

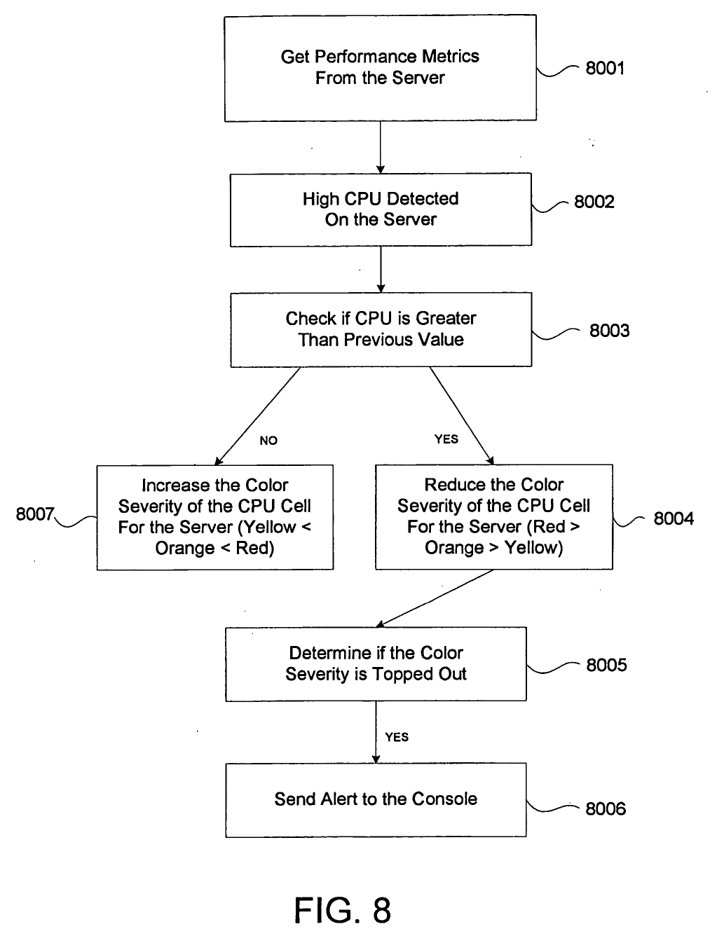

FIG. 8 shows yet another example of a process according to an embodiment of the invention, in which data concerning CPU performance is retrieved, analyzed, and alerted to a system administrator.

In step 8001, the system obtains performance metrics for a particular server, from an event log file of that server. In step 8002, the data from the event log file is analyzed and “High CPU” is detected, indicating that a high percentage of available CPU capacity is being utilized.

In step 8003, the system determines if the detected CPU value is greater than the CPU value last detected by the system for that server. If the answer is yes, the process proceeds to step 8004, in which the system changes the color of a section (cell) (in a GUI displaying performance measurements) providing CPU information for that server. Specifically, in a GUI used to provide the monitored data to a system administrator, a cell corresponding to the CPU level of the monitored server is changed among different colors (such as yellow, orange, and red) to represent different levels of severity of a potential problem. Consequently, in step 8004, if the CPU level is higher than the previously detected level, the color of the CPU cell in the graphical user interface is changed from yellow to orange or orange to red, to indicate an increase in threat severity.

In step 8005, the system determines whether the color severity is topped out at its highest level. In step 8006, if the color severity is topped out at its highest level, the system sends an alert to the console at which the graphical user interface is provided.

If, in step 8003, it is determined that the CPU level detected is not greater than the previously detected level, the process proceeds to step 8007. In step 8007, the color provided in the GUI for the CPU cell corresponding to the monitored server is changed to a color corresponding to a lesser threat severity.

Again, it would be appreciated by one of ordinary skill in the art that some of the steps presented above can occur in different orders, as necessary.

The present invention (or any part(s) or function(s) thereof) may be implemented using hardware, software or a combination thereof and may be implemented in one or more computer systems or other processing systems. However, the manipulations performed by the present invention were often referred to in terms, such as comparing or analyzing, which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers or similar devices.

In this document, the terms “computer program medium” and “computer usable medium” are used to refer generally to media such as removable a storage drive, a hard disk installed in hard disk drive, and signals. These computer program products provide software to components and systems of the invention. The invention is directed to such computer program products.

### VI. CONCLUSION

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary embodiments, but should be defined only in accordance with the following claims and their equivalents.

In addition, it should be understood that the figures and screen shots illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way. It is also to be understood that the steps and processes recited in the claims need not be performed in the order presented.

What is claimed is:

1. A computer program product comprising a computer-readable medium having control logic stored therein for causing a computer to monitor performance levels across a network, the control logic comprising:
first computer-readable program code for causing the computer to monitor, in real time, performance levels of (i) at least one program application operating on the network, and (ii) at least one component of infrastructure of the network;
second computer-readable program code for causing the computer to store data corresponding to the monitored performance levels;
third computer-readable program code for causing the computer to use the data to monitor trends in the performance levels of at least one of (i) the at least one application, and (ii) the at least component of infrastructure; and
fourth computer-readable program code for causing the computer, using the monitored trends in performance levels, to act to mitigate incidents detrimental to capabilities across the network that are potential results of the monitored trends.

2. A computer program product according to claim 1, wherein the fourth computer-readable program code causes the computer to mitigate a detrimental incident by alerting a user to at least one trend indicative of the detrimental incident.

3. A computer program product according to claim 1, wherein the fourth computer readable program code causes the computer to mitigate a detrimental incident by circumventing the component of infrastructure exhibiting a trend that indicates that that detrimental incident is currently possible.

4. A computer program product according to claim 1, wherein the monitored trends include fluctuations in performance levels selected from the group consisting of response times, CPU capacity occupied, error rates, and available logical memory.

5. A computer program product according to claim 1, further comprising fifth computer-readable program code for causing a display connected to the computer to display values corresponding to various performance levels, wherein the fourth computer-readable code causes the computer to mitigate a detrimental incident by alerting a user to at least one trend indicative of the detrimental incident by executing the fifth computer-readable program code to provide a visual alert on the display when a displayed value surpasses a predetermined threshold.

6. A computer program product according to claim 5, further comprising sixth computer-readable program code for causing a computer to enable a user to select one of the visual alert and the displayed value corresponding to the visual alert, using an interactive user interface, in order to cause the computer to display additional information concerning the performance level related to the displayed value surpassing the predetermined threshold.

7. A system for monitoring performance levels across a network, the system comprising:
a monitoring module for monitoring, in real time, performance levels of (i) at least one program application operating on the network, and (ii) at least one component of infrastructure of the network;
a storage module for storing data corresponding to the monitored performance levels;
a trend monitoring module for monitoring trends in the performance levels of at least one of (i) the at least one application, and (ii) the at least component of infrastructure; and
a mitigation module for, using the monitored trends in performance levels, mitigating incidents detrimental to capabilities across the network that are potential results of the monitored trends.

8. A system according to claim 7, wherein the mitigation module mitigates a detrimental incident by alerting a user to at least one trend indicative of the detrimental incident.

9. A system according to claim 8, wherein the mitigation module mitigates a detrimental incident by circumventing the component of infrastructure exhibiting a trend that indicates that that detrimental incident is currently possible.

10. A system according to claim 1, wherein the monitored trends include fluctuations in performance levels selected from the group consisting of response times, CPU capacity occupied, error rates, and available logical memory.

11. A system according to claim 7, further comprising a display module for displaying values corresponding to various performance levels, wherein the mitigation module mitigates a detrimental incident by alerting a user to at least one trend indicative of the detrimental incident by causing the display module to display a visual alert when a displayed value surpasses a predetermined threshold.

12. A system according to claim 11, further comprising an interface module for enabling a user to select one of the visual alert and the displayed value corresponding to the visual alert, in order to cause the computer to display additional information concerning the performance level related to the displayed value surpassing the predetermined threshold.

13. A method of monitoring performance levels across a network, the comprising the steps of:
monitoring, in real time, performance levels of (i) at least one program application operating on the network, and (ii) at least one component of infrastructure of the network;
storing data corresponding to the monitored performance levels;
monitoring trends in the performance levels of at least one of (i) the at least one application, and (ii) the at least component of infrastructure; and
mitigating, using the monitored trends in performance levels, incidents detrimental to capabilities across the network that are potential results of the monitored trends.

14. A method according to claim 13, wherein the mitigating step involves mitigating a detrimental incident by alerting a user to at least one trend indicative of the detrimental incident.

15. A method according to claim 13, wherein the mitigating step involves mitigating a detrimental incident by circumventing the component of infrastructure exhibiting a trend that indicates that that detrimental incident is currently possible.

16. A method according to claim 13, wherein the monitored trends include fluctuations in performance levels selected from the group consisting of response times, CPU capacity occupied, error rates, and available logical memory.

17. A method according to claim 1, further comprising a step of displaying values corresponding to various performance levels, wherein the mitigating step involves mitigating a detrimental incident by alerting a user to at least one trend indicative of the detrimental incident such that the displaying step displays a visual alert when a displayed value surpasses a predetermined threshold.

18. A method according to claim 17, further comprising a step of enabling a user to select one of the visual alert or the displayed value corresponding to the visual alert, using an interactive user interface, in order to cause the computer to display additional information concerning the performance level related to the displayed value surpassing the predetermined threshold.

19. A graphical user interface displayed on a display connected to a computer operating the graphical user interface, the graphical user interface comprising:
a first display area listing components of infrastructure across a network;
a second display area listing different categories of performance levels;
a third display are comprising a plurality of sub-areas, each sub-area displaying a performance level measurement corresponding to one of the different categories and pertaining to one of the listed components; and
a fourth display area displaying additional information relating to at least one of (i) a performance level category and (ii) at least one performance level for a particular component,
wherein a user may select information displayed in at least one of the first, second, and third display areas to cause the graphical user interface to display additional information concerning the user-selected information.
